(19) United States
(12) Patent Application Publication
(10) Pub. No.: US 2009/0033196 A1
(43) Pub. Date: Feb. 5, 2009

(54) Electron emission source, electron emission device and method of preparing the electron emission source

(76) Inventors: Young-Mi Cho, Suwon-si (KR); Chang-Wook Kim, Suwon-si (KR); Hee-Sung Moon, Suwon-si (KR)

Correspondence Address: CHRISTIE, PARKER & HALE, LLP, PO BOX 7068, PASADENA, CA, 91109-7068, US

(21) Appl. No.: 12/154,035

(22) Filed: May 19, 2008

(30) Foreign Application Priority Data
Jul. 30, 2007 (KR) 1020070076429

(51) Int. Cl. H01J 1/02

(52) U.S. Cl. 313/309

(57) ABSTRACT

Electron emission sources, electron emission devices including the electron emission sources, and methods of making the electron emission sources are provided. The electron emission source includes a carbon-based material, and a degradation prevention material for preventing degradation of the carbon-based material. A binding energy between the degradation prevention material and external oxygen is greater than a binding energy between the carbon-based material and the external oxygen. The electron emission sources have excellent field emission efficiencies and long lifetimes.

### CROSS-REFERENCE TO RELATED PATENT APPLICATION

This application claims priority to and the benefit of Korean Patent Application No. 10-2007-0076429, filed on Jul. 30, 2007 in the Korean Intellectual Property Office, the entire content of which is incorporated herein by reference.

### BACKGROUND OF THE INVENTION

1. Field of the Invention

The present invention relates to electron emission sources, electron emission devices, and methods of preparing the electron emission sources. More particularly, the invention is directed to an electron emission source comprising a carbon-based material and a degradation prevention material for preventing degradation of the carbon-based material, an electron emission device including the electron emission source, and a method of preparing the electron emission source.

2. Description of the Related Art

An electron emission device is a device that emits light by emitting electrons from an electron emission source under an electric field that is generated when a voltage is applied between the anode and the cathode and by collision of electrons with a phosphor layer.

Carbon-based materials, including carbon nanotubes (CNTs) with good electron conductivity, have good conductivity and field enhancement effects, low work functions, good field emission properties, low driving voltages, and enable large scale device fabrication. Therefore, carbon-based materials have been used as electron emission materials for electron emission sources.

CNT-based electron emission sources can be fabricated by growing CNTs on a substrate by, for example, chemical vapor deposition (CVD) or pasting of CNT-containing, electron emission source-forming compositions. Pasting enables large scale fabrication of electron emission sources at low cost.

However, in conventional electron emission sources, during operation of the electron emission device, active gases are absorbed into the electron emission material (e.g. CNTs or the like), or the electron and atom structures of the electron emission material change due to Joule heat generated during operation. As a result, the properties of the electron emission material can be degraded. Therefore, conventional electron emission sources do not have satisfactory field emission efficiency and lifetime properties.

### SUMMARY OF THE INVENTION

One embodiment of the present invention provides an electron emission source comprising a carbon-based material and a degradation prevention material for preventing degradation of the carbon-based material. According to another embodiment, an electron emission device includes the electron emission source. In yet another embodiment, a method of preparing the electron emission source is provided.

According to an embodiment of the present invention, an electron emission source comprises a carbon-based material, and a degradation prevention material for preventing degradation of the carbon-based material, wherein the binding energy between the degradation prevention material and external oxygen is greater than the binding energy between the carbon-based material and the external oxygen.

According to another embodiment of the present invention, an electron emission device comprises the above-described electron emission source.

According to another embodiment of the present invention, a method of preparing the electron emission source comprises providing a degradation prevention material selected from metals, metal oxides, and combinations thereof. The method further comprises preparing an electron emission source formation composition comprising the degradation prevention material, the carbon-based material and a vehicle. The method further comprises printing the electron emission source formation composition on a substrate and heat-treating the composition.

The electron emission sources according to embodiments of the present invention have excellent field emission efficiencies and long lifetimes. Thus, electron emission devices including the electron emission sources have improved operating stability, can have low starting voltages, and can be manufactured at low cost using driving ICs.

### BRIEF DESCRIPTION OF THE DRAWINGS

The patent or application file contains at least one drawing executed in color. Copies of the patent or patent application publication with color drawings will be provided by the Office upon request and payment of the necessary fee.

The above and other features and advantages of the present invention will become more apparent by reference to the following detailed description when considered in conjunction with the attached drawings in which:

FIG. 1A is a cross-sectional view of an electron emission source according to one embodiment of the present invention;

FIG. 1B is a cross-sectional view of an electron emission source according to another embodiment of the present invention;

FIG. 2 is a schematic perspective view of an electron emission device according to an embodiment of the present invention;

FIG. 3 is a cross-sectional view taken along line II-II of FIG. 2;

FIGS. 4A, 4B and 4C are first-principle calculation models of carbon nanotubes (CNTs) on which a metal or a metal oxide is coated;

FIG. 4D is a graph of the density of states of a CNT coated with a metal, wherein the density of states is obtained using first-principle calculation on the electronic structure;

FIG. 4E is a first-principle calculation model of a binding energy between a carbon-based material and external oxygen;

FIG. 4F is a first-principle calculation model of a binding energy between a degradation prevention material and external oxygen;

FIG. 5A is a transmission electron microscopic (TEM) image of a CNT coated with Pd;

FIG. 5B is an electronic data change (EDX) graph of a CNT coated with Pd;

FIG. 6 is a TEM image of a CNT coated with SnO₂;

FIG. 7 is a graph comparing electric field with respect to current density of an electron emission source containing a CNT coated with Ti according to an embodiment of the present invention and a conventional electron emission source; and

FIG. 8 is a graph comparing time with respect to current density of an electron emission source containing a CNT coated with Ti according to an embodiment of the present invention and a conventional electron emission source.

### DETAILED DESCRIPTION OF THE INVENTION

One embodiment of the present invention provides an electron emission source comprising a carbon-based material. The carbon-based material may be any material having good field emission properties. Nonlimiting examples of suitable carbon-based materials include carbon nanotubes, carbon nanohorns, fullerene, carbon nanorods, silicon carbide, amorphous carbon, and the like. In some embodiments, the carbon-based material can be a mixture of at least two carbon-based materials.

In one embodiment, the carbon-based material may be a material including at least one carbon nanotube. A carbon nanotube is a carbon allotrope in which a graphite sheet is rolled into a tube shape with a nano-sized diameter. Carbon nanotubes may be single-walled or multi-walled. CNTs may be prepared by chemical vapor deposition (CVD), such as thermal CVD, DC plasma CVD, RF plasma CVD, or microwave plasma CVD.

When an electron emission source comprising the carbon-based material is included in an electron emission device, degradation of the carbon-based material may occur, resulting in a rapid reduction in current density. The degradation of the carbon-based material may occur due to a number of causes. First, electrons may not be smoothly transported due to structural defects in the carbon-based material, and thus the current resistance of the carbon-based material increases. Then, the carbon material is rapidly destructured by Joule heat and degrades. Second, the carbon-based material is structurally changed through an electro-chemical reaction generated between the carbon-based material and radicals derived from the carbon deposit (obtained by a heat-treating vehicle or the like contained in the electron emission source formation composition) existing in the electron emission source and active gas (such as oxygen or the like) existing in a cell of the electron emission source. As a result, the carbon-based material may degrade. Third, if the carbon-based material is disposed on a cathode electrode, the carbon-based material may be degraded by heat generated locally by an increase in contact resistance between the carbon-based material and the cathode electrode. In extreme cases, the carbon-based material may become detached from the cathode electrode. Fourth, the carbon-based material may be degraded by field evaporation by a local increase in current density of an end portion of the carbon-based material.

Degradation of the carbon-based material can be caused as described above, but other causes exist and are not limited to the ones described. To prevent the degradation of the carbon-based material, in addition to including the carbon-based material, the electron emission source according to embodiments of the present invention includes a degradation prevention material for preventing degradation of the carbon-based material. The degradation prevention material may be selected from metals, metal oxides and combinations thereof.

The degradation prevention material may be a coating coated on the surface of the carbon-based material. Alternatively, the degradation prevention material may be particles in the electron emission source.

When coated on the surface of the carbon-based material, the degradation prevention material reduces exposure of structural defects on the surface of the carbon-based material and alleviates electron scattering potential at the structural defect site, thereby reducing current resistance. In addition, the degradation prevention material reduces the surface area in which radicals derived from carbon deposits existing in the electron emission source and active gas existing in a cell (such as oxygen or the like) can be directly reacted with the carbon-based material, thus preventing degradation of the carbon-based material. Accordingly, the electron emission sources have improved field emission efficiencies and lifetimes.

The binding energy between the degradation prevention material and external oxygen is greater than the binding energy between the carbon-based material and the external oxygen. More particularly, the binding energy between a metal (which can be the degradation prevention material) and external oxygen is greater than the binding energy between the carbon-based material and the external oxygen. In addition, the binding energy between the metal of a metal oxide (which can be the degradation prevention material) and the external oxygen is greater than the binding energy between the carbon-based material and the external oxygen.

The metal (when used as the degradation prevention material) can react with external oxygen faster than the carbon-based material. Therefore, when the metal is attached to the carbon-based material, or the metal exists around the carbon-based material, the reaction between the external oxygen and the carbon-based material is inhibited. Accordingly, the degradation of the carbon-based material due to external oxygen can be reduced.

In addition, the binding energy between the metal of a metal oxide (when used as the degradation prevention material) and external oxygen is greater than the binding energy between the carbon-based material and the external oxygen, and thus the metal oxide itself is stable with respect to an active gas, for example, external oxygen. Therefore, the degradation of the carbon-based material due to the external oxygen can be effectively prevented.

In particular, the metal is coated on the surface of the carbon-based material, and thus additional emitting sites are increased, effective barrier tunneling is reduced, and electron distribution around the Fermi Level, contributing to electron emission, can be increased. Therefore, field emission efficiency can be increased. Alternatively, the metal oxide is coated on the surface of the carbon-based material, and thus a surface work function of the carbon-based material which emits electrons is reduced due to the electron affinity of the metal oxide. As a result, electron emission can be increased.

In addition, the degradation prevention material, existing in the form of particles in the electron emission source reduces contact resistance between the carbon-based material and the cathode electrode, thereby preventing the degradation of the carbon-based material. Thus, the electron emission source has improved lifetime. In addition, the degradation prevention material physically and uniformly disperses the carbon-based material in the electron emission source and support, and thus can improve the luminance uniformity of the electron emission source.

More particularly, the binding energy between the metal (or the metal of the metal oxide) and the external oxygen may be greater than or about 1 eV greater than the binding energy between the carbon-based material and the external oxygen. In one embodiment, for example, the binding energy between the metal (or the metal of the metal oxide) is greater than or about 3 eV greater than the binding energy between the carbon-based material and the external oxygen. When the binding energy between the metal (or the metal of the metal oxide) and the external oxygen satisfies the above-mentioned ranges, degradation of the carbon-based material can be effectively reduced.

The metal of the degradation prevention material may have a melting point of about 1000 K or greater. In one embodiment, for example, the metal has a melting point of about 1500 K or greater. When the melting point of the metal is less than about 1000 K, the metal can melt due to Joule heat generated during heat-treatment of the electron emission source or during electron emission operation.

The binding energy between the metal of the degradation prevention material and the carbon-based material may be greater than about 0 eV. In one embodiment, for example, the binding energy between the metal of the degradation prevention material and the carbon-based material is greater than about 1.5 eV. When the binding energy between the metal of the degradation prevention material and the carbon-based material satisfies the above-mentioned ranges, the metal coated on the surface of the carbon-based material is not easily separated from the carbon-based material.

The metal of the degradation prevention material may have a work function ranging from about 3 eV to about 6 eV. In one embodiment, for example, the metal has a work function ranging from about 4 eV to about 5.5 eV. When the work function of the metal is greater than about 3 eV, charges can easily be supplied from the electron emission source. When the work function of the metal is less than about 6 eV, effective electron emission efficiency can be obtained.

The metal of the degradation prevention material is not particularly limited, and can be any metal which satisfies the above mentioned conditions such as ionization energy, melting point, binding energy with the carbon-based material, work function, and the like. Nonlimiting examples of the metal of the degradation prevention material include Al, Ti, V, Mn, Fe, Co, Ni, Cu, Zn, Ga, Zr, Mo, Ru, Pd, Pt, In, Sn, W, and the like, and mixtures thereof. In one embodiment, for example, the metal may be Co, Ni, Fe, Ti, Al, Mo, W, Mn, Cu, Pd, Ru, Pt, or the like.

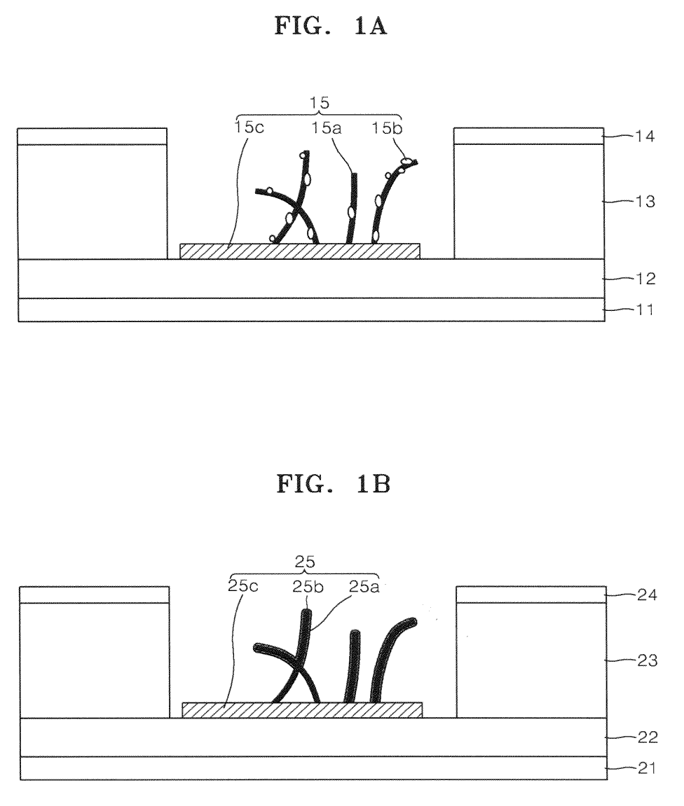

To increase electron emission efficiency, the metal as described above may be coated as islands on the surface of the carbon-based material, as illustrated in FIG. 1A. FIG. 1A depicts an electron emission device according to an embodiment of the present invention. As shown in FIG. 1A, the electron emission device includes a substrate 11, a cathode electrode 12, an insulating layer 13, a gate electrode 14 and an electron emission source 15. The electron emission source 15 includes a carbon-based material 15a on which a metal 15b is coated. The electron emission source 15 may further include a carbon deposit 15c which is formed due to heat-treating vehicles or the like contained in the electron emission source formation composition.

When the metal as described above is coated on the surface of the carbon-based material, the metal may cover from about 5% to about 50% of the surface area of the carbon-based material. In one embodiment, for example, the metal may cover from about 10% to about 40% of the surface area of the carbon-based material. When the metal is coated to cover more than about 5% of the surface area of the carbon-based material, degradation of the carbon-based material can be effectively prevented. When the metal is coated to cover less than about 50% of the surface area of the carbon-based material, satisfactory field emission efficiencies can be obtained.

When the metal as described above exists in the electron emission source as particles (for example, the metal is added to the electron emission source formation composition), an average particle diameter of the metal may range from about 10 nm to about 5 μm. In one embodiment, for example, the metal may have an average particle diameter ranging from about 20 nm to about 100 nm. When the average particle diameter of the metal is greater than about 10 nm, aggregation of metal particles can be substantially prevented. When the average particle diameter of the metal is less than about 5 μm, degradation of electron emission efficiencies can be prevented.

The metal oxide of the degradation prevention material may have an energy band gap of greater than about 4 eV. When the energy band gap of the metal oxide is greater than about 4 eV, the absorption of ultraviolet rays or visible rays is substantially prevented during exposure performed for printing of the electron emission source formation composition. Therefore, effective printing of the electron emission source formation composition can be performed.

The metal oxide of the degradation prevention material may have an electron affinity ranging from about 3 eV to about 7 eV. In one embodiment, for example, the metal oxide has an electron affinity ranging from about 4 eV to about 6 eV. When the electron affinity of the metal oxide is about 3 eV or greater, charge supplies from the electron emission source can be smoothly implemented. When the electron affinity of the metal oxide is about 7 eV or less, effective electron emission from the surface of the carbon-based material on which the metal oxide is coated can be performed.

The metal oxide may have a melting point of about 1000 K or greater. In one embodiment, for example, the metal oxide may have a melting point of about 1500 K or greater. When the melting point of the metal oxide is about 1000 K or greater, melting of the metal oxide due to Joule heat generated during heat-treatment of the electron emission source or during operation of the electron emission source can be substantially prevented.

The metal oxide of the degradation prevention material is not particularly limited, and can be any metal oxide which satisfies the above mentioned selection conditions regarding energy band gap, electron affinity, melting point, and the like. Nonlimiting examples of suitable metal oxides include Al₂O₃, Co₂O₄, Cu₂O, In₂O₃, MgO, RuO₂, SiO₂, SnO₂, TiO₂, ZnO, and the like, and combinations thereof. In one embodiment, for example, the metal oxide may be Cu₂O, MgO, SnO₂, ZnO, or the like.

To increase electron emission efficiency, the metal oxide as described above may be coated continuously on the surface of the carbon-based material as illustrated in FIG. 1B. That is, the metal oxide may be coated on the surface of the carbon-based material in the form of a metal oxide layer. FIG. 1B depicts an electron emission device according to an embodiment of the present invention. As shown in FIG. 1B, the electron emission device includes a substrate 21, a cathode electrode 22, an insulating layer 23, a gate electrode 24 and an electron emission source 25. The electron emission source 25 includes a carbon-based material 25a on which a metal oxide 25b is coated. The electron emission source 25 may further include a carbon deposit 25c which is formed due to the presence of heat-treating vehicles or the like contained in the electron emission source formation composition.

The metal oxide layer coated on the surface of the carbon-based material may have a thickness ranging from about 1 nm to about 20 nm. In one embodiment, for example, the metal oxide layer has a thickness ranging from about 5 nm to about 15 nm. When the thickness of the metal oxide layer is about 1 nm or thinner, degradation of the carbon-based material can not be effectively prevented. When the thickness of the metal oxide layer is greater than about 20 nm, effective field emission can not be obtained.

When the metal oxide as described above exists in the electron emission source in the form of particles (for example, the metal oxide is added to the electron emission source formation composition), an average particle diameter of the metal oxide may range from about 10 nm to about 5 μm. In one embodiment, for example, the average particle diameter may range from about 20 nm to about 100 nm. When the average particle diameter of the metal oxide is about 10 nm or greater, aggregation of metal oxide particles can be substantially prevented. When the average particle diameter of the metal oxide is about 5 μm or smaller, effective electron emission efficiencies can be obtained.

The metal or metal oxide used as the degradation prevention material can be selected using the first-principle calculation of electronic structure. For example, to determine whether an arbitrary metal A is suitable as the degradation prevention material, the density of states of each of a CNT when the metal A is attached and a CNT when the metal A is not attached is obtained using the first-principle calculation of electronic structure. The method of obtaining density of states of a material using first-principle calculation of electronic structure is known in the art. Subsequently, if a value obtained from integrating the density of states of the CNT having the metal A attached thereto from a Fermi level to a level 1 eV below the Fermi level is greater than the same value for the CNT not having the metal A attached thereto, the metal A can be employed as the degradation prevention material.

According to one embodiment of the present invention, the electron emission source as described above may be included in an electron emission device. The electron emission device may include, for example, a substrate, a cathode electrode on the substrate, a gate electrode electrically insulated from the cathode electrode, and an insulating layer between the cathode electrode and the gate electrode for insulating the cathode electrode and the gate electrode. The electron emission source is an electron emission source including a carbon-based material and a degradation prevention material for preventing degradation of the carbon-based material. The degradation prevention material is selected from metals and metal oxides, as described above.

The electron emission device may further include various structures, for example, a second insulating layer covering an upper portion of the gate electrode, a focusing electrode insulated from the gate electrode by the second insulating layer and disposed in parallel with the gate electrode, and the like.

The electron emission device can be used in various electronic devices, for example, a backlight unit of a liquid crystal display, or the like, or electron emission apparatuses.

According to another embodiment of the present invention, an electron emission apparatus includes a first substrate, a plurality of cathode electrodes disposed on the first substrate, a plurality of gate electrodes disposed substantially perpendicular to the cathode electrodes, an insulating layer disposed between the cathode electrodes and the gate electrodes and insulating the cathode electrodes and the gate electrodes, electron emission source holes formed in sites at which the cathode electrodes and the gate electrodes intersect, electron emission sources arranged in the electron emission source holes, a second substrate disposed substantially parallel to the first substrate, an anode disposed on the second substrate, and a phosphor layer.

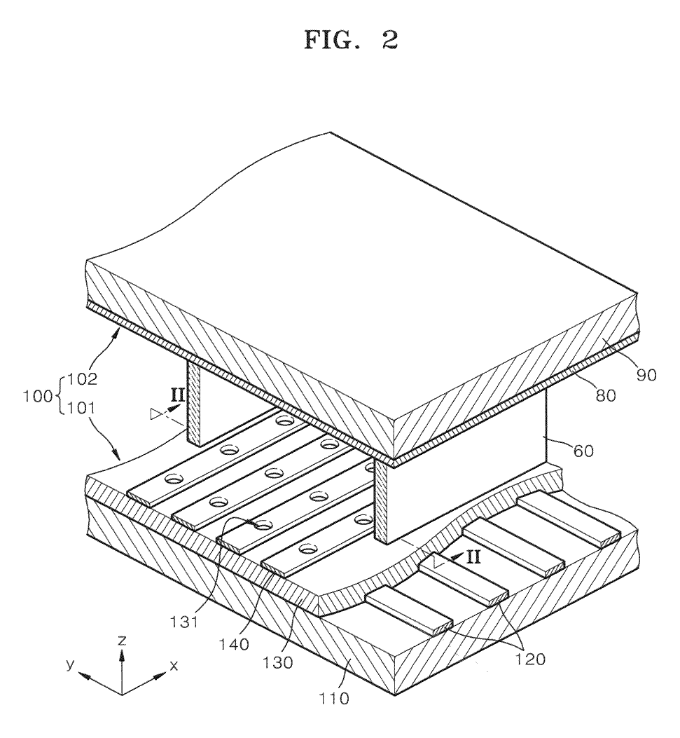

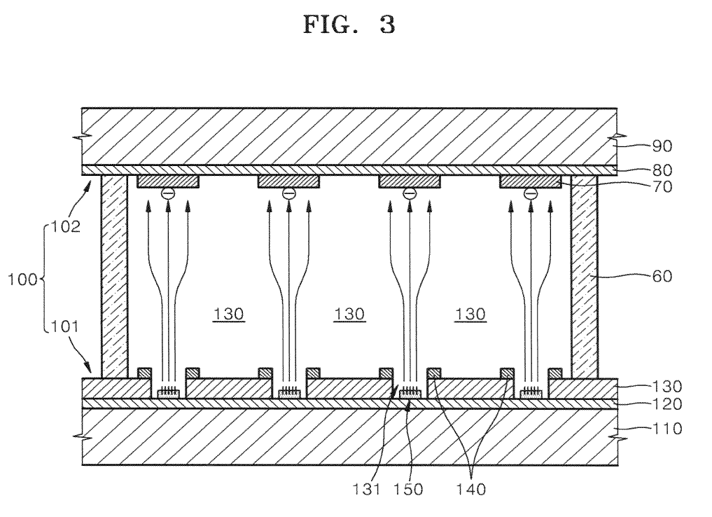

FIG. 2 is a partial perspective view illustrating the structure of a top-gate type electron emission apparatus according to an embodiment of the present invention. FIG. 3 is a cross-sectional view taken along a line II-II of FIG. 2. As illustrated in FIGS. 2 and 3, an electron emission apparatus 100 according to one embodiment of the present invention includes an electron emission device 101 and a front panel 102, which are disposed in parallel and form a vacuum light emitting space 103. The apparatus 100 further includes a spacer 60 which maintains an interval between the electron emission device 101 and the front panel 102.

According to one embodiment, the electron emission device 101 includes a first substrate 110, gate electrodes 140 and cathode electrodes 120 on the first substrate 110 intersecting each other, and an insulating layer 130 disposed between the gate electrodes 140 and the cathode electrodes 120 to electrically insulate the gate electrodes 140 and cathode electrodes 120.

Electron emission source holes 131 are formed in the areas where the gate electrodes 140 and the cathode electrodes 120 intersect, and electron emission sources 150 are disposed in the holes 131. The electron emission sources 150 include a carbon-based material and a degradation prevention material for preventing degradation of the carbon-based material. The degradation prevention material is selected from metals, metal oxides, and combinations thereof, as described above.

The front panel 102 includes a second substrate 90, an anode electrode 80 disposed on a first surface of the second substrate 90, and a phosphor layer 70 disposed on a first surface of the anode electrode 80.

The electron emission apparatus according to embodiments of the present invention is described with reference to FIGS. 2 and 3, but various alternative structures are also possible, such as an electron emission apparatus including a second insulating layer and/or a focusing electrode.

According to another embodiment of the present invention, a method of preparing the electron emission source includes providing a degradation prevention material selected from metals, metal oxides, and combinations thereof, coating the degradation prevention material on a surface of a carbon-based material, preparing an electron emission source formation composition including the carbon-based material coated with the degradation prevention material and vehicles, printing the electron emission source formation composition on a substrate, and heat-treating the printed electron emission source formation composition.

Alternatively, the method of preparing the electron emission source may include providing a degradation prevention material selected from metals, metal oxides, and combinations thereof, preparing an electron emission source formation composition including the degradation prevention material, a carbon-based material and vehicles, printing the electron emission source formation composition on a substrate, and heat-treating the printed electron emission source formation composition.

First, a degradation prevention material is selected from a group of metals, metal oxides, and combinations thereof. The selection involves selecting a metal, metal oxide or combination thereof that satisfies the corresponding selection conditions. The selection conditions for a metal include ionization energy, melting point, binding energy with the carbon-based material, work function, and the like. The selection conditions for a metal oxide include energy band gap, electron affinity, melting point, and the like.

Selecting the degradation prevention material can be performed by, for example, a first-principle calculation of electronic structure. According to the first-principle calculation of electronic structure, the degradation prevention material is selected based on electron emission efficiency forecasts obtained by analyzing the density of states (DOS) of a carbon-based material coated with a degradation prevention material from a Fermi energy level to 1 eV. In particular, a metal oxide can be selected based on current with respect to voltage properties obtained by calculating tunneling current of a metal oxide using a wigner-kramers-brillouin (WKB) model.

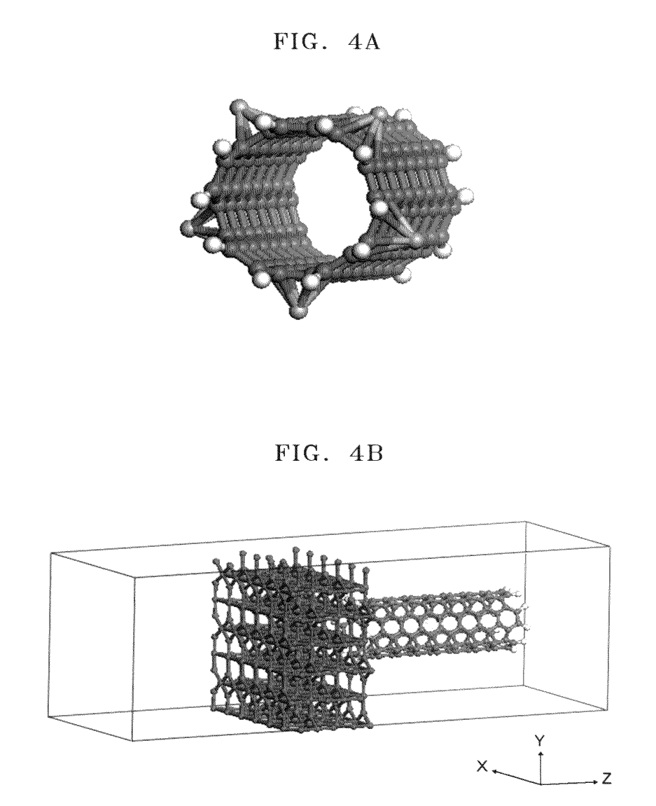

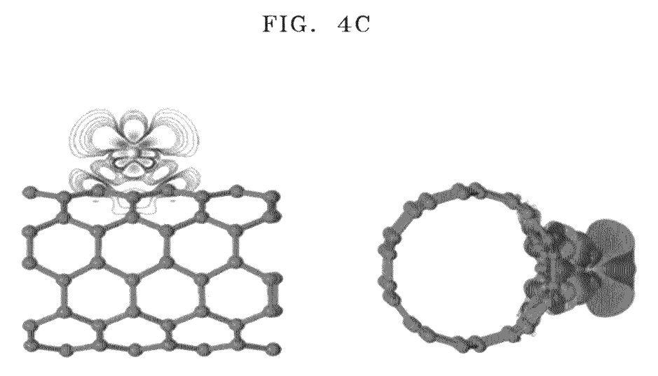

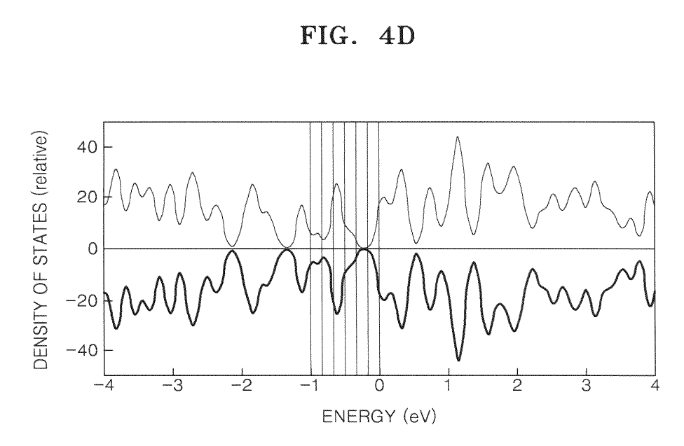

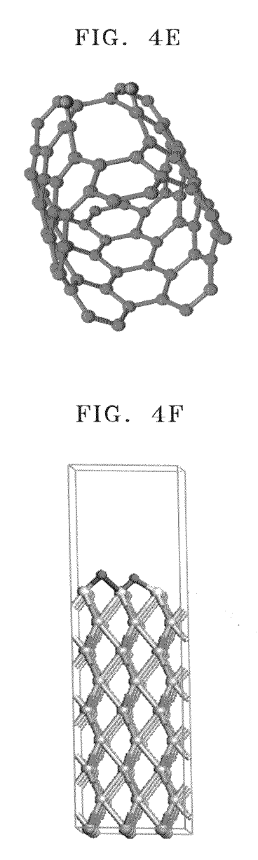

FIG. 4A illustrates a first-principle calculation model for a carbon-based material on which a metal is coated in the form of particles, wherein the carbon-based material is modeled at the molecular level. FIG. 4B illustrates a first-principle calculation model for a carbon-based material on which a metal oxide is coated entirely, wherein the carbon-based material is modeled at the molecular level. FIG. 4C illustrates charge distribution results of a CNT coated with Ti. By performing a first-principle calculation of electronic structure, the charge distribution of the CNT coated with the degradation prevention material can be obtained, and an electron structure of the CNT can be analyzed from the charge distribution. FIG. 4D is a graph of the density of states of a CNT coated with Ti, and the Fermi level is fixed at 0 eV. An integrated value from the Fermi level to a level 1 eV below the Fermi level indicates a probability of electron emission by tunneling.

The binding energy between a CNT and external oxygen as described above can also be calculated using a first-principle calculation of electronic structure. FIG. 4E shows a first-principle calculation model for obtaining a binding energy between the CNT and the external oxygen. The binding energy between the CNT and the external oxygen obtained from the calculation is about 0.41 eV. FIG. 4F shows a first-principle calculation model for obtaining a binding energy between Ti and the external oxygen. The binding energy between Ti and the external oxygen obtained from the calculation is about 11.38 eV.

The selected degradation prevention material can be coated on the surface of the carbon-based material, and the coated carbon-based material can be mixed with an electron emission source formation composition. Alternatively, the selected degradation prevention material can be directly added to the electron emission source formation composition along with the carbon-based material.

The selected degradation prevention material may be coated on the surface of the carbon-based material using various known methods. For example, a reduction method using metal salts can be used. The reduction method is performed by adding a carbon-based material to a solution including a metal salt, and then reducing the metal salt to extract the degradation prevention material on the surface of the carbon-based material, thereby coating the degradation prevention material on the surface of the carbon-based material. By adjusting the concentration of the solution including the metal salt, or other parameters of the reduction method (for example, types and amounts of added reducing agent, heat-treatment temperature and time), the amount of the degradation prevention material coated on the surface of the carbon-based material can be adjusted.

An electron emission source formation composition includes the carbon-based material coated with the degradation prevention material and vehicles. Alternatively, as described above, the electron emission source formation composition may include the degradation prevention material, the carbon-based material, and vehicles. The carbon-based material and the degradation prevention material are described above.

The vehicle in the electron emission source-formation composition is used to adjust the printability and viscosity of the electron emission source-formation composition. The vehicle may include a resin component and a solvent component. Nonlimiting examples of suitable resin components include cellulose resins (such as ethyl cellulose and nitro cellulose), acrylic resins (such as polyester acrylate, epoxy acrylate, urethane acrylate, and ethyl methacrylate (EMA)), and vinyl resins (such as polyvinyl acetate, polyvinyl butyral, and polyvinyl ether). Some of the above-listed resin components can also serve as photosensitive resins.

Nonlimiting examples of suitable solvent components include terpineol, butyl carbitol (BC), butyl carbitol acetate (BCA), toluene, and texanol. In one embodiment, for example, terpineol is used.

The resin component and the solvent component may be included in the vehicle in a weight ratio ranging from about 0.5:99.5 to about 20:80. In one embodiment, for example, the weight ratio ranges from about 5:95 to about 15:85.

The vehicle and the carbon-based material (or the carbon-based material coated with the degradation prevention material) may be included in the electron emission-formation composition in a weight ratio ranging from about 99.5:0.5 to about 95:5. In one embodiment, for example, the weight ratio ranges from about 99:1 to about 97:3. When the amount of the vehicle is outside of these weight ratio ranges, the printability and viscosity of the electron emission source formation composition are reduced. In particular, when the amount of the vehicle is greater than the above mentioned weight ratio ranges, the drying time of the composition is too long.

In addition, the electron emission source formation composition may further comprise an adhesive component, a photosensitive resin, and a photoinitiator, if desired. The adhesive component is used to attach the electron emission source to a substrate and may be, for example, an inorganic binder, etc. Nonlimiting examples of suitable inorganic binders include frit, silane, water glass, etc. The inorganic binder may be a mixture of two or more materials. The frit may be composed, for example, of lead oxide-zinc oxide-boron oxide (PbO—ZnO—B₂O₃). In one embodiment, frit is used as the inorganic binder.

According to one embodiment of the present invention, the amount of the inorganic binder in the composition ranges from about 10 to about 59 parts by weight based on 100 parts by weight of the carbon-based material or the carbon-based material coated with the degradation prevention material. In one embodiment for example, the inorganic binder is present in the composition in an amount ranging from about 15 to about 35 parts by weight based on 100 parts by weight of the carbon-based material or the carbon-based material coated with the degradation prevention material. If the amount of the inorganic binder is less than about 10 parts by weight based on 100 parts by weight of the carbon-based material, sufficient adhesive force cannot be attained. If the amount of the inorganic binder is more than about 50 parts by weight based on 100 parts by weight of the carbon-based material, printability may be reduced.

The photosensitive resin is used for patterning the electron emission source. Nonlimiting examples of suitable photosensitive resins include acrylate-based monomers, benzophenone-based monomers, acetophenone-based monomers, and thioxanthone-based monomers. For example, the photosensitive resin may be epoxy acrylate, polyester acrylate, 2,4-diethyloxanthone, or 2,2-dimethoxy-2-phenylacetophenone. The amount of the photosensitive resin may range from about 1000 to about 2000 parts by weight based on 100 parts by weight of the carbon-based material or the carbon-based material coated with the degradation prevention material. In one embodiment, for example, the amount of the photosensitive resin ranges from about 1500 to about 2000 parts by weight based on 100 parts by weight of the carbon-based material or the carbon-based material coated with the degradation prevention material. If the amount of the photosensitive resin is less than about 1000 parts by weight based on 100 parts by weight of the carbon-based material, exposure sensitivity may be reduced. On the other hand, if the amount of the photosensitive resin exceeds about 2000 parts by weight based on 100 parts by weight of the carbon-based material, developing may be poor.

The photoinitiator is used to initiate the cross-linking reaction of the photosensitive resin upon exposure. The photoinitiator may be benzophenone but is not limited thereto. The amount of the photoinitiator may range from about 300 to about 1000 parts by weight based on 100 parts by weight of the carbon-based material or the carbon-based material coated with the degradation prevention material. In one embodiment, for example, the amount of the photoinitiator ranges from about 300 to about 700 parts by weight based on 100 parts by weight of the carbon-based material or the carbon-based material coated with the degradation prevention material. If the amount of the photoinitiator is less than about 300 parts by weight based on 100 parts by weight of the carbon-based material, patterning may be poor due to inefficient cross-linking reaction. On the other hand, if the amount of the photoinitiator exceeds about 1000 parts by weight based on 100 parts by weight of the carbon-based material, manufacturing costs may be increased.

Next, the electron emission source-formation composition is printed on a substrate at an electron emission source formation region. As used herein, the term “substrate” refers to a substrate intended for formation of an electron emission source. The type of substrate may change according to the desired electron emission device, which is within the skill of ordinary persons in the art. For example, in fabricating an electron emission device including a gate electrode between a cathode and an anode, the substrate may be the cathode. In fabricating an electron emission device including a gate electrode on one side of the cathode, the substrate may be an insulating layer insulating the cathode and the gate electrode.

Printing of the electron emission source formation composition may be performed by, for example, photolithography using a photoresist pattern. First, a photoresist pattern is formed on a substrate using a known method. Then, the electron emission source formation composition is applied, exposed to light and developed. As a result, the electron emission source formation composition can be printed on the electron emission source formation region. However, the printing method is not limited to the above-mentioned method.

Next, the electron emission source formation composition printed on the electron emission source formation region is heat-treated as described above. Due to the heat-treatment, the adhesive force between the carbon-based material in the composition and the substrate can be increased, at least a portion of the vehicle can be volatized from the composition, and other components such as the inorganic binder, etc. can be melted and solidified to improve durability of the electron emission source. The heat-treatment temperature is determined according to the evaporation temperature and evaporation time of the vehicle contained in the electron emission source-formation composition. In one embodiment, however, the heat-treatment temperature ranges from about 400 to 500° C., for example 450° C. If the heat-treatment temperature is less than about 400° C., vehicle evaporation may be insufficient. On the other hand, if the temperature exceeds about 500° C., manufacturing costs may be increased and the substrate may be damaged.

Heat-treating of the printed electron emission source formation composition may be performed in the presence of an inert gas in order to prevent the degradation of the carbon-based material. Nonlimiting examples of suitable inert gases include nitrogen gas, argon gas, neon gas, xenon gas, and mixtures thereof.

The surface of the heat-treated composition is selectively activated in order to vertically arrange the carbon-based material, expose the surface of the carbon-based material, or the like. For example, the activation may be performed by coating a solution that can be cured in the form of a film using thermal treatment. For example, the solution may include a surface treating agent for an electron emission source (e.g. a polyimide-based polymer) and may be coated on the heat-treated product, thermally treated, and then the formed film is peeled off. Alternatively, the activation may be performed by forming an adhesive element on a surface of a roller which is driven using a driving source and pressing a surface of the heat-treated product using the roller at a pressure. Due to this activation, the carbon-based material can be controlled to be exposed at the surface of the electron emission source or to be vertically arranged on the substrate.

The following examples are presented for illustrative purposes only and do not limit the scope of the invention.

### EXAMPLES

### Example 1

(A) Preparation of Carbon Nanotubes Coated with Pd

0.5 g of carbon nanotube (manufactured by CNI) was added to 100 ml of deionized water, and then sonicated for 5 minutes. First, 10 wt % of a PdCl₂ solution was separately prepared by adding palladium chloride (PdCl₂) powder (manufactured by Aldrich) to deionized water, and then 20 ml of the PdCl₂ solution was added to the carbon nanotube-containing deionized water while being sonicated. 20 ml of 1 M NaBH₄ solution was dropped into the mixture using a micropipette, and then allowed to stand for 10 minutes. The resultant was filtered using a 7 μm filter, and then washed using deionized water. Then, the resultant was dried for 2 hours in an oven at a temperature of 100° C. (at atmospheric atmosphere) to obtain carbon nanotubes coated with Pd.

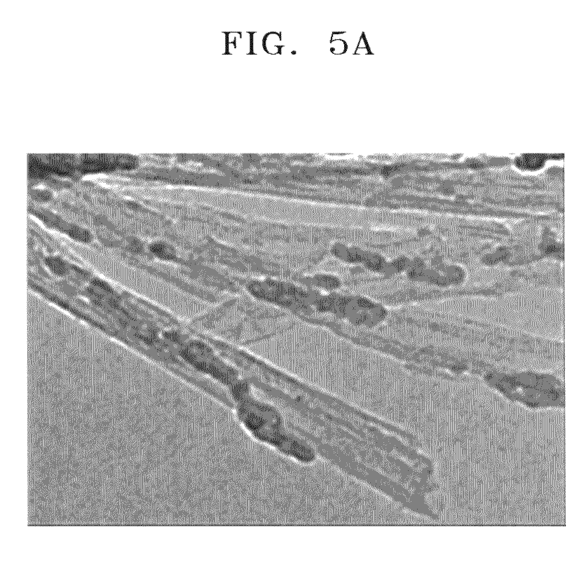

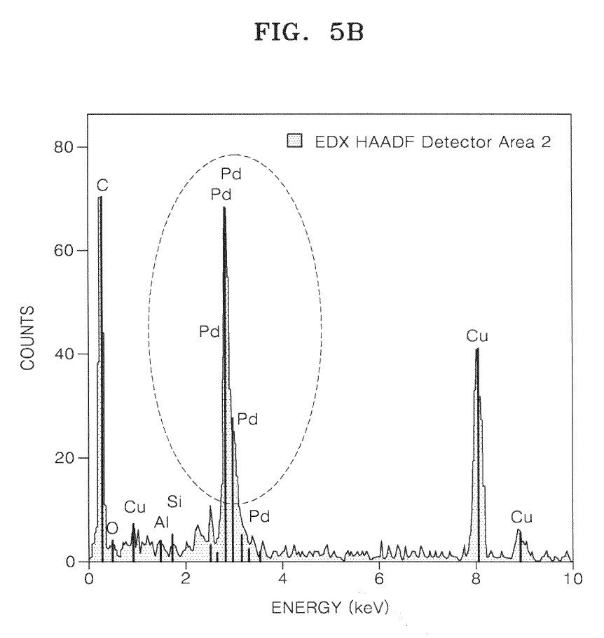

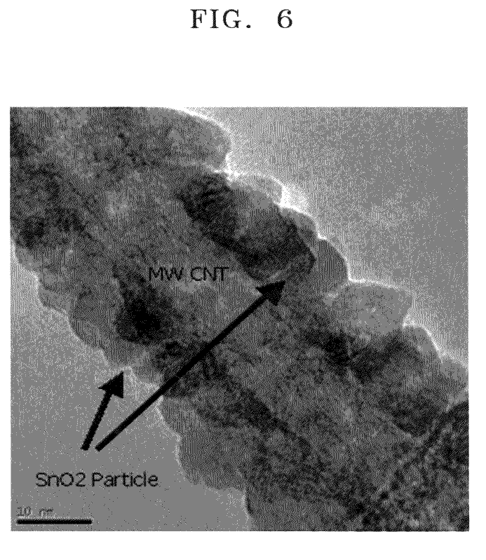

FIG. 5A is a transmission electron microscope (TEM) image of the carbon nanotubes coated with Pd. FIG. 5B is an electronic data change (EDX) graph of the carbon nanotubes coated with Pd. From FIGS. 5A and 5B, it can be confirmed that Pd is coated on the surface of the carbon nanotubes.

(B) Preparation of Electron Emission Source including the Carbon Nanotubes Coated with Pd

Ethyl methacrylate (EMA) and Terpineol were mixed in a weight ratio of 1.8:98.2 to prepare a vehicle. Then, the carbon nanotube powder coated with Pd was added to the vehicle (a weight ratio of the vehicle to the carbon nanotube powder coated with Pd was 98.5:1.5). The mixture was milled using a Thinky mill, and then roll milled using a 3 roll mill by adjusting the pressure of the roll by 7 steps to obtain an electron emission source forming composition. The electron emission source forming composition was screen printed on an ITO substrate to a size of 0.5 cm×0.5 cm, dried in an electric furnace at 60° C. for 20 minutes, and then heat-treated at 450° C. in the presence of nitrogen gas to prepare an electron emission source. This electron emission source is referred to as Sample 1.

### Example 2

(A) Preparation of Carbon Nanotubes Coated with SnO₂

0.5 g of carbon nanotubes (manufactured by CNI) was added to 100 ml of deionized water, and then sonicated for 5 minutes. First, 10 wt % of a SnCl₂ solution was separately prepared by adding tin chloride (SnCl₂) powder (manufactured by Aldrich) to deionized water, and then 20 ml of the SnCl₂ solution was added to the carbon nanotube-containing deionized water while being sonicated. Then, the mixture was put into an electric furnace under atmospheric pressure, and then the temperature of the electric furnace was raised to 400° C. The temperature of the electric furnace remained at 400° C. for 20 minutes, and was then cooled down to room temperature. The resultant was filtered using a 7 μm filter, and then washed using deionized water. Then, the resultant was dried for 2 hours in an oven at a temperature of 100° C. (atmospheric pressure) to obtain carbon nanotubes coated with SnO₂.

FIG. 6 is a transmission electron microscope (TEM) image of the carbon nanotubes coated with SnO₂. In FIG. 6, it can be confirmed that SnO₂ is coated on the surface of the carbon nanotubes.

(B) Preparation of Electron Emission Source including the Carbon Nanotubes Coated with SnO₂

An electron emission source was prepared as in Example 1, except that the carbon nanotubes coated with SnO₂ were used instead of the carbon nanotubes coated with Pd. This electron emission source is referred to as Sample 2.

### Example 3

(A) Preparation of Carbon Nanotube Coated with Ti

A carbon nanotube coated with Ti was prepared as in Example 1, except that titanium chloride (TiCl₃) powder (manufactured by Aldrich) was used instead of PdCl₂ powder.

(B) Preparation of Electron Emission Source including the Carbon Nanotube Coated with Ti

An electron emission source was prepared as in Example 1, except that the carbon nanotubes coated with Ti were used instead of the carbon nanotubes coated with Pd. This electron emission source is referred to as Sample 3.

### Comparative Example

An electron emission source was prepared as in Example 1, except that carbon nanotubes (manufactured by CNI) were used instead of the carbon nanotubes coated with Pd. This electron emission source is referred to as Comparative Sample A.

### Evaluation Example

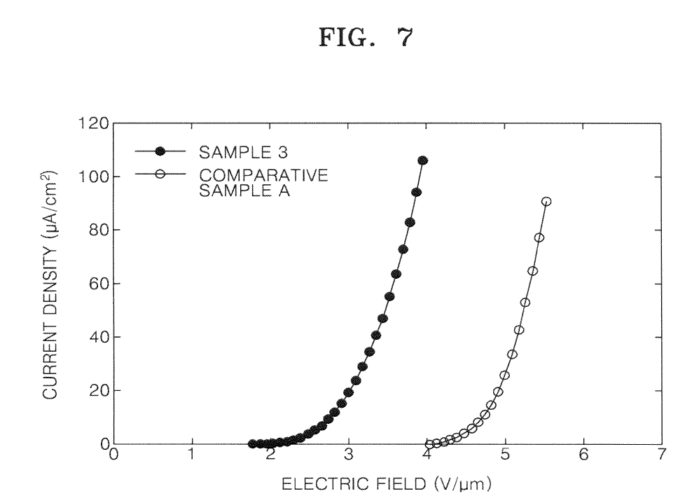

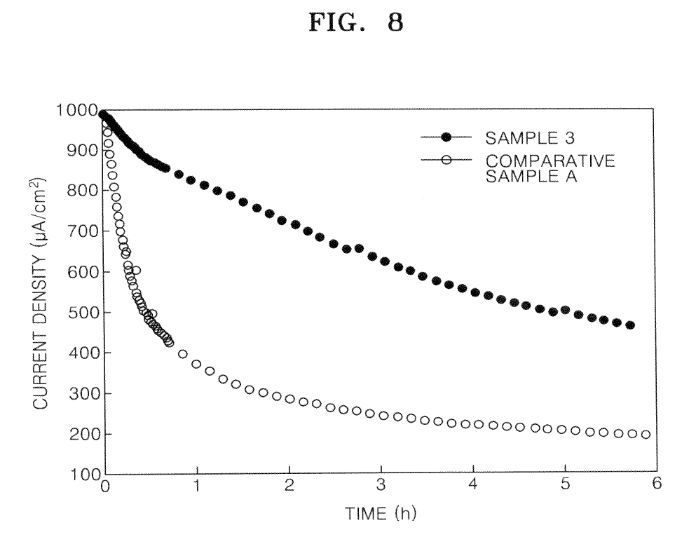

FIGS. 7 and 8 compare the field emission efficiency and lifetime evaluation results of Sample 3 and Comparative Sample A. Field emission efficiency was evaluated by measuring current density according to electric field, and lifetime was evaluated by measuring current density according to time. Current density was measured using equipment for evaluating diode emission (Motech Vacuum, High voltage pulse generator, PG-5K5A, PEE Co., Ltd.) including a pulse power and a vacuum chamber. The vacuum chamber had a degree of vacuum of less than 10⁻⁶ torr, and the vacuum chamber was equipped with a Cu anode and a 114 μm OHP film as a spacer. Efficiency properties were measured at 1/500 duty. Two-step aging was performed for 5 hours by applying 200 μA/cm² at 1/5000 duty. Lifetime was evaluated by observing time (that is, the time at which current density is reduced by half) starting from 1 mA/cm² at 1/100 duty down to 0.5 mA/cm².

Referring to FIG. 7, Comparative Sample A, which is a conventional electron emission source, has a maximum current density of 90 μA/cm² in the range of from 4 V/μm to 5.5 V/μm. However, Sample 3, which is an electron emission source according to an embodiment of the present invention, has a maximum current density of 110 μA/cm² in the range of from 2 V/μm to 4 V/μm. From the result, it can be seen that the electron emission source according to Sample 3 has excellent field emission efficiency compared to the conventional electron emission source.

Referring to FIG. 8, Comparative Sample A, which is a conventional electron emission source, has a current density half-life of about 0.5 hours. However, Sample 3, which is an electron emission source according to an embodiment of the present invention, has a current density half-life of about 5 hours. From the result, it can be seen that the electron emission source according to Sample 3 has a much longer lifetime than the conventional electron emission source.

An electron emission source according to embodiments of the present invention includes a carbon-based material and a degradation prevention material for preventing degradation of the carbon-based material. Thus, the electron emission sources according to the present invention have excellent field emission efficiencies and long lifetimes. Electron emission devices including the electron emission sources have improved operating stability and improved lifetime properties, and can be manufactured at low cost using driving ICs.

While the present invention has been illustrated and described with reference to certain exemplary embodiments, it will be understood by those of ordinary skill in the art that various changes may be made to the described embodiments without departing from the spirit and scope of the present invention as defined by the following claims.

What is claimed is:

1. An electron emission source comprising:
a carbon-based material; and
a degradation prevention material for preventing degradation of the carbon-based material, wherein a binding energy between the degradation prevention material and external oxygen is greater than a binding energy between the carbon-based material and the external oxygen.

2. The electron emission source of claim 1, wherein the degradation prevention material is selected from the group consisting of metals, metal oxides and combinations thereof.

3. The electron emission source of claim 1, wherein the binding energy between the degradation prevention material and the external oxygen is greater than or about 1 eV unit greater than the binding energy between the carbon-based material and the external oxygen.

4. The electron emission source of claim 1, wherein the carbon-based material is selected from the group consisting of carbon nanotubes, carbon nanohorns, fullerene, carbon nanorods, silicon carbide, amorphous carbon, and combinations thereof.

5. The electron emission source of claim 1, wherein the degradation prevention material is coated on a surface of the carbon-based material.

6. The electron emission source of claim 1, wherein the degradation prevention material comprises particles in the electron emission source.

7. The electron emission source of claim 1, wherein a melting point of the degradation prevention material is about 1000 K or greater.

8. The electron emission source of claim 2, wherein the degradation prevention material comprises a metal, and a binding energy between the metal of the degradation prevention material and the carbon-based material is about 0 eV or greater.

9. The electron emission source of claim 2, wherein the degradation prevention material comprises a metal, and a work function of the metal ranges from about 3 eV to about 6 eV.

10. The electron emission source of claim 2, wherein the degradation prevention material comprises a metal selected from the group consisting of Al, Ti, V, Mn, Fe, Co, Ni, Cu, Zn, Ga, Zr, Mo, Ru, Pd, Pt, In, Sn, W, and combinations thereof.

11. The electron emission source of claim 2, wherein the degradation prevention material comprises a metal coated on a surface of the carbon-based material, the metal covering from about 5% to about 50% of a surface area of the carbon-based material.

12. The electron emission source of claim 2, wherein the degradation prevention material comprises metal particles in the electron emission source, an average particle diameter of the metal particles ranging from about 10 nm to about 5 μm.

13. The electron emission source of claim 2, wherein the degradation prevention material comprises a metal oxide, an energy gap of the metal oxide being about 4 eV or greater.

14. The electron emission source of claim 2, wherein the degradation prevention material comprises a metal oxide, an electron affinity of the metal oxide ranging from about 3 eV to about 7 eV.

15. The electron emission source of claim 2, wherein the degradation prevention material comprises a metal oxide selected from the group consisting of Al₂O₃, Co₂O₄, Cu₂O, In₂O₃, MgO, RuO₂, SiO₂, SnO₂, TiO₂, ZnO, and combinations thereof.

16. The electron emission source of claim 2, wherein the degradation prevention material comprises a metal oxide coated on a surface of the carbon-based material to a thickness ranging from about 1 nm to about 20 nm.

17. The electron emission source of claim 2, wherein the degradation prevention material comprises metal oxide particles in the electron emission source, an average particle diameter of the metal oxide particles ranging from about 10 nm to about 5 μm.

18. The electron emission source of claim 1, wherein the degradation prevention material is selected using a first-principle calculation of electronic structure.

19. The electron emission source of claim 18, wherein an integrated value of a density of states of a coated carbon-based material coated with the degradation prevention material from a Fermi level to a level 1 eV below the Fermi level is greater than an integrated value of a density of states of an uncoated carbon-based material not coated with the degradation prevention material from a Fermi level to a level 1 eV below the Fermi level, wherein the density of states of the coated carbon-based material and the uncoated carbon-based material are obtained by first-principle calculations of electronic structure.

20. An electron emission device comprising:
a substrate;
at least one cathode electrode on the substrate;
the electron emission source according to claim 1;
at least one gate electrode electrically insulated from the cathode electrode; and
an insulating layer between the cathode electrode and the gate electrode, and insulating the cathode electrode and the gate electrode.
